(19) United States
(12) Patent Application Publication
(10) Pub. No.: US 2010/0052849 A1
(43) Pub. Date: Mar. 4, 2010

(54) SWITCHING DEVICE

(75) Inventors: Bernd Steegmann, Heiligenhaus (DE); Ulrich Muller, Velbert (DE)

Correspondence Address: CANTOR COLBURN, LLP, 20 Church Street, 22nd Floor, Hartford, CT, 06103, US

(73) Assignee: HUF HULSBECK & FURST GMBH & CO. KG, Velbert (DE)

(21) Appl. No.: 12/280,007

(22) PCT Filed: Feb. 16, 2007
(86) PCT No.: PCT/EP2007/051506

§ 371 Date: Jul. 28, 2009

(30) Foreign Application Priority Data
Feb. 20, 2006 (DE) 10 2006 008 145.5
Oct. 9, 2006 (DE) 10 2006 048 372.3

(51) Int. Cl. G05B 19/00; E05B 65/12

(52) U.S. Cl. 340/5.64; 70/237

(57) ABSTRACT

The invention relates to a switching device (1) for the keyless activation or deactivation of a consumer, especially an engine or the like in a vehicle, and/or for unlocking or locking a functionally essential component of a vehicle. Said device comprises at least one switching element (3), arranged inside a housing (2), which can be actuated by an actuation element (4), thereby generating at least one switching signal for the control unit (10). The aim of the invention is to provide a switching device which consists of only few components and which is incorporated into a keyless security system in a simple manner. For this purpose, an electrode (5) is provided on the housing (2) and is connected to the control unit (10). Said electrode (5) transmits data to a mobile ID transmitter (13) and the electrode (5) allows data being transmitted to a mobile ID transmitter (13) via a capacitative coupling (32, 34). The control unit (10) transmits a first encoded and/or modulated signal to the electrode (5) when the latter receives a first switching signal from the switching element (3). The invention also relates to a security system (25) for the keyless activation or deactivation of an installation or a device, especially of a steering wheel lock or of an engine in a vehicle. Said system comprises a switching device (1) according to the invention, and a mobile ID transmitter (13), capacitative data transmission between the switching device (1) and the ID transmitter (13) being possible, and a control unit (10) which controls data transmission between the switching device (1) and the mobile ID transmitter (13).

### FIELD OF THE INVENTION

The present invention is directed toward a switching device for keyless switching on or switching off a load, especially an engine, etc., in a vehicle, and/or unlocking or locking a vehicle component essential to function. Such a device is provided, for example, in the interior of a vehicle, preferably within reach of a driver, and is incorporated in a security system, especially of a vehicle. Various switching processes can be performed by the switching device.

The invention is also directed toward a security system for keyless activation or deactivation of a unit or device, especially a steering-wheel lock or an engine in a vehicle.

### BACKGROUND OF THE INVENTION

Unexamined patent application DE 198 38 992 A1, which discloses a starter switch for vehicles with electronic steering lock, is known from the state of the art. This ignition starter switch is operated like a comparable mechanical ignition key during starting or stopping of the engine. Since this ignition starter switch also functions in a keyless manner, a transmitting and receiving device is additionally provided that serves to identify an authorized user and, after identification, unlocks the ignition starter switch, so that it is freely operable. The ignition starter switch itself is unlocked or locked by an additional electromechanical lockout controlled by a control unit inside the vehicle. Actual release for unlocking is produced by a mobile ID transmitter (electronic key). Because of the prescribed electromechanical locking of the ignition starter switch, the number of mechanical components is additionally increased, so that the weight of the switch and the required manufacturing costs are significantly increased.

Another type of ignition starter switch is disclosed in unexamined patent application EP 1,468,884 A2. No mechanical lockout device is provided in this ignition starter switch to rule out unauthorized operation of the switch. This ignition starter switch is also incorporated in a security system, the switch being additionally provided with a coil antenna, in order to direct a so-called wakeup or activation signal by radio waves to a mobile ID transmitter as soon as the switch is activated. Starting of the engine is then possible only if the required identification code is sent by the ID transmitter and checked on the vehicle side by a control unit and recognized as admissible (in the sense of correct).

If the correct identification code is involved, the additional switching commands that start from the switch can be conveyed and converted by the corresponding electrical or electromechanical components or devices in the vehicle. It has been found in practice that security systems based on radio can be bypassed by a radio link extension. Such a system can be bypassed particularly simply if the wakeup or activation signal on the vehicle side, which generally only has a range of a few meters, is extended to the actual location of the mobile ID transmitter, since this then independently emits the far-reaching identification signals of the vehicle.

In order to avoid the radio link extension in security systems just described, systems have recently been in use, in which data exchange occurs through a capacitive coupling. For example, one such security system is further described in unexamined patent application DE 101 32 031 A1. However, this security system is exclusively directed toward an access authorization system, in order to release access to a protected area only in case there is a positive identification.

### BRIEF SUMMARY OF THE INVENTION

The present invention provides a switching device that consists of few components and is simply incorporated in a keyless security system. The present invention also provides an improved and simple security system for keyless activation or deactivation of a unit or device, especially in the area of vehicles.

According to the invention, the switching device has an electrode on the housing that is connected to a control unit, the electrode serving for data transmission to a mobile ID transmitter (electronic key or electronic identification device). This electrode permits, by capacitive coupling, data transmission to the mobile ID transmitter, whereby the control unit sends a first coded and/or modulated signal to the electrode when it receives a first switching signal from the switching element. The present switching device is therefore also used to send the activation or wakeup signal to the mobile ID transmitter. This signal is not transmitted by an inductance or electromagnetic waves, but by means of the capacitive electrode, through which capacitive coupling with the ID transmitter is possible. As soon as the mobile ID transmitter receives this capacitive signal, it sends, for example, an identification signal, especially a radio signal at 433.22 MHz or 868 MHz, to the electronics inside the vehicle, in order to release the security system. In this method, the actual capacitive signal is transmitted directly by the body of an operator or driver. As soon as the operator wishes to use the switching device to switch on or switch off a device, he must, on the one hand, touch the operating element, so that capacitive coupling occurs to his body. On the other hand, capacitive coupling between his body and the mobile ID transmitter can occur if the operator carries the mobile ID transmitter with him. For this purpose, the mobile ID transmitter is also equipped with an electrode. Through indirect contact between the operating element and the mobile ID transmitter by the body of the operator, capacitive coupling then occurs between the two parts, which is simultaneously used for data transmission. It is then not necessary for the operator to touch the two electrodes for capacitive data transmission directly. Advantageously, electrical insulation is provided between the electrodes (in the switching device and in the ID transmitter) and the operator. The actual data signal flows as a weak current of a few microamperes through or over the human body of the operator, specifically from the source to the destination. It is therefore not possible to query this data signal from the outside without authorization. Consequently, much higher security is guaranteed than in ordinary radio transmission of the activation or wakeup signal. It is also conceivable to convey the identification signal in reverse from the ID transmitter to the switching device by capacitive coupling to the security system.

Because of the switching device according to the invention, operator comfort of a vehicle can be further increased, since during activation of the switching device, an identification process for the switching signal occurs simultaneously. Only with correct identification, is the signal sent from the switching device to the control unit further processed, so that the engine-management system or other devices are activated or deactivated.

For example, a vehicle can also be started without operating an ignition key in an ignition lock, since the required identification automatically occurs by the operating element merely being touched by the operator. This type of system is also called a “passive drive system.” In this case, a mobile ID transmitter can be used simultaneously not only for a so-called “passive entry system,” but also for a “passive drive system” for keyless activation or deactivation of a device, such as starting a load and/or unlocking and locking a vehicle component essential to function. Naturally, present security devices, such as an electrical steering-wheel lock and/or an electrical immobilizer, can also be used in order to secure the vehicle against theft. Activation or deactivation of these security devices occurs as a function of the corresponding switching signal (the switching device) by the control unit, if the correct identification signal is sent to the control unit by the mobile ID transmitter.

In this way, an ordinary ignition lock with ignition key (switch position 0 to III) can be replaced with a one-stage switching device (switching states 0 and I), since the functionality or desired control process can be stipulated by the control unit. This control process can be stored as a program in the control unit. For example, authorized access to the vehicle can correspond to switch position I of an ordinary ignition lock. Brief activation of the switching device or stepping on the brake pedal can serve for switching engine management or the ignition on, for unlocking the steering wheel lock and/or the immobilizer, and for activation of additional electrical loads, comparable to the switch position II of an ordinary ignition lock. Further operation of the switching device can then lead to starting the engine, comparable to switch position III of an ordinary ignition lock. It is also conceivable that the engine-management system and the engine are activated when, for example, the brake pedal and the switching device are operated simultaneously. When the switching device is further operated, the engine and the engine-management system can be switched off again (switch position I of an ordinary ignition lock). Leaving and/or locking the vehicle can serve to switch the electrical loads off, comparable to switch position 0 of an ordinary ignition lock.

In a special embodiment of the switching device, the switching element has different switch positions, a distinct switching signal being assigned to each switch position, which is sent to the control unit by operating an operating element. It is possible to form not only the states on and off, but additional or comparable switching states can also be formed, as in an ordinary ignition lock. For this purpose, the switching element can consist of an ordinary raster, key, switch, rotary switch, etc., in order to form the different switching states that are necessary. It is then particularly desirable if operation of the switching device takes place in a manner comparable to an ordinary ignition lock. For this purpose, the switching element can assume different switch positions by a translatory and/or rotary movement of the operating element. For this purpose, combined keys and rotary switches can be used as switching elements. It is also conceivable that two or more switching elements are arranged in a switching device connected to the control unit. Additional possibilities for using the switching device can be produced thereby. For example, it is conceivable that programming of a navigation system (GPS system) is possible only if the operator has been identified by the mobile ID transmitter. Use of a radio telephone can also be secured by such a switching device. Naturally, other application possibilities are also conceivable for this switching device.

As already mentioned, capacitive coupling occurs between the electrode (on the vehicle side) provided in or on the switching device according to the invention and the mobile ID transmitter, if electrical insulation is provided on the corresponding capacitive electrode. The housing or the operating element of the switching device can be used as electrical insulation for this purpose. The housing of the mobile ID transmitter can also be used as electrical insulation for the capacitive electrode in the ID transmitter. For this purpose, corresponding electrodes are arranged inside the housing. The electrical insulation can preferably consist of a non-conducting plastic.

In order to accommodate the capacitive electrode in the switching device optimally, it can be made in several parts, the individual parts of the electrodes being connected in an electrically conducting manner to one another. The electrode can be arranged, on the one hand, in the operating element and, on the other hand, in the housing of the switching device. The electrode is configured in plate and/or film-form for optimal capacitive coupling. It has proven to be appropriate to arrange the electrode over a large area behind the surface of the operating element and/or the housing. For this purpose, the electrode can be mounted on the back on the inside surface of the operating element. It is also conceivable to arrange the electrode directly in the housing or the operating element. The electrode itself can consist of an electrically conducting metal.

To obtain the most detailed possible information concerning individual switching processes or switching states of the switching device or individual device in the security system or in a vehicle, an optical and/or acoustic display element can additionally be present in the switching device. This display device can be provided, on the one hand, in the operating element and/or, on the other hand, in the housing. The display device itself can be an LED or a display, etc. It should be mentioned in this context that the operating element can generally be at least mechanically operated, but not all functions need to be included in the corresponding switching positions, since these depend on whether the operator can be identified as authorized by the corresponding mobile ID transmitter. Consequently, arbitrary operation of the switching device is conceivable, which, however, does not lead to any functional triggering if the operator is not carrying the ID transmitter.

If the above-mentioned display device is used, a film can also be used that has transparent areas. An inscription, symbol, etc., can be displayed in the switching device by a simple light source through these transparent areas. For example, the operating element can be illuminated or shown from the rear through the display element. In order to be able to blend an inscription in, for example, the area of the inscription must be transparent in the film. For this purpose, a metal foil can have corresponding recesses punched, lasered, etched or incorporated in some other way. The transparent areas can be generated in this way. It is also conceivable to configure this film to be electrically conducting, whereby metal or plastic films can be used that simultaneously serve as (capacitive) electrodes for data exchange. It is also conceivable to use a luminescent film for display of the display element as an electrode for data exchange. The advantage of an electrically conducting film as an electrode is seen in the fact that it is arranged directly behind or in the operating element, so that shielding of the conducting surface of the film by additional interfering objects is essentially avoided.

Another variant of the switching device can also have a sensor element with a support surface, whereby a test object, especially a finger of an operator, can be placed on the support surface, which can be identified by the sensor element. Such a sensor element is disclosed, for example, by unexamined patent application EP 0,805,247 A1. The required support surface of the sensor element can be provided, for example, on the surface of the operating element. The surface of the housing can also serve for arrangement of the support surface. An additional security query can be conducted by the additional sensor element. It is then also conceivable that only the sensor element serves in the switching device for identification of an authorized operator, if, for example, the mobile ID transmitter should be defective. Since the operator must operate the operating element in any case when he intends to start the engine of a vehicle, for example, no additional step or operation is necessary for him to release the engine-management system, an electrical steering-wheel lock, etc.

The switching device according to the invention appropriately also has a power transmission unit, so that electrical power can be transmitted from the switching device to the mobile ID transmitter in such a way that it remains functional without its own power supply or during failure of its power supply. Mobile ID transmitters often have a mechanical key, in order to permit access to a vehicle or secured area during battery failure. However, the security system cannot permit activation or switching on of the device in question without identification of the ID transmitter. It is ensured by the power transmission unit in the switching device that the ID transmitter also has the necessary power, if, for example, its battery is too weak. An inductive or capacitive power transmission can occur for this purpose, for which a coil or electrode in the switching device and ID transmitter are provided. If the operator now finds that the ID transmitter, because of a power deficiency, no longer operates perfectly, he can bring the ID transmitter into the vicinity of the switching device, so that power transmission is made possible and the security system can permit release of the device in question by identification of the ID transmitter.

The switching device according to the invention, because of its space-saving configuration, can also be arranged in or on the steering wheel itself, especially in the area of an emblem or the area of impact or gripping surfaces. Only one or a few electrical conductors emerge from this switching device, so that simple cabling itself is possible in the steering wheel. The switching device according to the invention therefore need not be arranged to be hidden and scarcely accessible, like a mechanical steering-wheel lock. It is even conceivable to arrange the switching device on the gear lever, on a center console, on a multifunctional operating unit on the dashboard, on an inside panel of a door, on the roof liner, on the inside of the rearview mirror or on the left or right of the steering wheel in the vehicle. Operating comfort during starting of the engine, etc., can thereby be significantly increased, since the ergonomic requirements of the driver can be considered.

The present invention is also directed toward a base security system for keyless activation or deactivation of a system or device, especially a steering-wheel lock (which is considered a functionally important component in a vehicle) or an engine in a vehicle. This security system is equipped with a switching device according to the invention and a mobile ID transmitter, whereby capacitive data transmission can occur between the switching device and the ID transmitter. A control unit that controls at least data transmission through the switching device and mobile ID transmitter is additionally provided on the security system. In this security system, the driver or operator of the vehicle need not be actively identified in order to release or activate the system. Only by operating the switching device, especially the operating element, is the identification process automatically started, in which case capacitive data transmission is used to transmit the coded wakeup or activation signal from the switching device to the ID transmitter. After the mobile ID transmitter has received and checked this wakeup signal, it sends the actual identification code back to the security system. This can also occur, on the one hand, by capacitive data transmission or by an additional receiving unit that receives the identification data by radio from the mobile ID transmitter and conveys it to the control unit. The control unit then compares the identification data (regardless of whether it was received by radio or by capacitive data transmission) with the stipulated identification data and then performs a corresponding check of the individual loads or devices in case of positive identification, depending on which switch position or which switch signal of the switching device is present. For example, the electrical steering-wheel lock can be unlocked and the engine-management system can be released, in order for the engine in a vehicle to be started.

The mobile ID transmitter can also be used for keyless access to a blockable area, especially the interior of a passenger compartment interior, in which the ID transmitter is also incorporated in the access-control system of the vehicle. To increase operational security (in this case, not theft), an electrode can additionally be provided in the driver's seat of a vehicle, which is also connected to the control unit, the electrode serving for capacitive data transmission to the mobile ID transmitter. It is thereby possible that starting a load in the vehicle is only possible if the operator, who is carrying the mobile ID transmitter, is also actually sitting in the driver's seat. Unintended starting of the engine can be prevented by this means.

### BRIEF DESCRIPTION OF THE DRAWINGS

Additional measures and advantages of the invention can be seen from the claims, the following description, and the drawings. The invention will be presented in several embodiment examples in the drawings. In the drawings:

FIG. 1 shows a schematic overview of the security system according to the invention, with the switching device essential according to the invention,

FIG. 2 shows a side view of the switching device according to the invention in partial section, with an operating element to be operated in a translatory manner,

FIG. 3 shows a side view of another switching device according to the invention, with an operating element to be operated in a rotary manner, in a view comparable to FIG. 2,

FIG. 4 shows a top view of the switching device from FIG. 3,

FIG. 5 shows a side view of a comparable switching device from FIG. 2, but with another arrangement of the capacitive electrode and an integrated power-transmission unit, and

FIG. 6 shows a top view of another switching device, with an integrated display element.

### DETAILED DESCRIPTION OF THE PREFERRED EMBODIMENTS

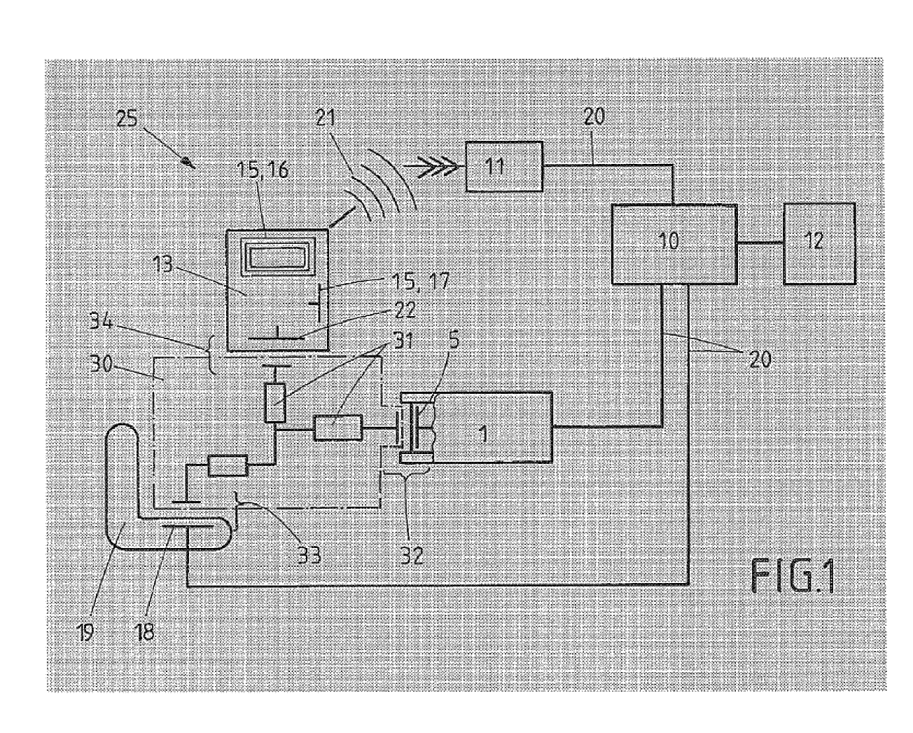

An overview of a security system 25 is shown purely schematically in FIG. 1. This drawing shows only the essential electronic and mechanical components. In a secured area, such as a the interior space of a passenger compartment, the switching device 1, as well as the control unit 10, the receiving unit 11, and the management system 12, are arranged. This can preferably be a so-called “passive keyless drive system”, which is used, for example, as a supplement to a so-called “passive keyless entry system.” The same mobile ID transmitter 13 can then be used for both systems. This mobile ID transmitter 13 is an electronic identification device that replaces the mechanical key of ordinary security systems. After the operator 30 has achieved access to the secured area, keyless activation of a load, for example, an engine in the vehicle and/or unlocking of an electric steering-wheel lock, is also to be produced by the security system 25. For this purpose, the operator 30 need only operate the switching device 1 with the corresponding operating element 4. Through the required touching of the operating element 4, capacitive coupling occurs between the switching device 1 and the mobile ID transmitter 13 carried by the operator 30. For this purpose, the switching device 1 has an electrode 5 arranged in or on the switching device 1. Another electrode 22 is also provided in the ID transmitter 13, so that capacitive coupling occurs between the operator 30 and the mobile ID transmitter 13. The operator 13 himself therefore represents the connection element between the electrode 5 in the switching device 1 and the electrode 22 in the ID transmitter 13. The operator 30 himself is represented as the resistor or resistors (R) with reference number 31 in the circuit diagram. In the overview picture (see FIG. 1), depiction of the ground connection of the system is omitted. The elements 22, 15, 16, 17 shown in the ID transmitter 13 are generally not visible, since they are situated within the housing of the ID transmitter.

If the operator 30 now presses on the operating element 4 with his hand or finger, capacitive coupling automatically occurs between electrode 5 and the finger. This capacitor (C1) bears reference number 32. The signal being transmitted capacitively consists of an electrical alternating field conveyed over the skin of operator 30. This alternating field can be generated by an oscillator, for example, in the switching device 1 or the control unit 10. The mobile ID transmitter 13 receives this capacitive signal through its electrode 22, which can be arranged within its housing when the operator 30 carries the ID transmitter with him. The capacitive signal can itself be coded or keyed. If the ID transmitter 13 has identified the signal received from switching device 1 as an admissible wakeup or activation signal, it, in turn, sends an identification signal back to the control unit 10. This can also be a capacitive signal that is sent back in the same way as the already mentioned wakeup signal. It is also conceivable that the mobile ID transmitter 13 sends a radio signal through a radio link 21 to a receiving unit 11. This receiving unit 11 then sends the received signal to the control unit 10 for evaluation. For this purpose, the receiving unit 11 is connected to the control unit 10 by a connection 20. If the identification signal is sent back to the switching device 1 through a capacitive coupling, the receiving unit 11 in the security system 25 can be omitted.

The identification signal received from the mobile ID transmitter 13 is now compared or evaluated in the control unit 10. If it is then found that the mobile ID transmitter 13 has sent the correct identification signal, the actual switching state (for example, 0 or I) of the switching device 1 is considered by the control unit 10, in order to send a corresponding activation or deactivation of a load or corresponding control signal to another unit, such as the (engine-)management system 12, so that the engine can be started. The electrical steering wheel lock and/or the electrical immobilizer can thereby also be unlocked previously or simultaneously.

To switch the engine off, an additional operating of the switching device 1 can be used, which then sends the switching signal to the control unit 10. The control unit 10 compares the received switching signal with the current engine state and sends a switch-off signal to the engine management system 12, if the corresponding identification signal has been found beforehand by the ID transmitter 13. Switching off of the engine is possible in this case.

Switching on and switching off an engine, as well as securing and unlocking a vehicle, can be depicted by the corresponding switching states of the switching device 1 as an ordinary mechanical ignition-lock switch. For example, it is then conceivable that only locking of the electrical steering-wheel lock occurs when the mobile ID transmitter 13 is no longer situated in inside the vehicle.

Additional electrodes that are acted upon by a capacitive activation signal in a specified time interval can be provided to locate the ID transmitter 13 in the secured space or vehicle interior. As soon as the ID transmitter 13, after receiving the activation signal, is reported by its identification signal, the system 25 establishes the electrode of the ID transmitter with which it is in capacitive connection. The position of the ID transmitter 13 can be clearly determined by this. It is then conceivable that available electrical lines and/or electrically conducting surfaces, such as mirror surfaces, chrome surfaces, etc., in the vehicle are used as additional electrodes for location of the ID transmitter 13. It can also be established by the system 25 whether an additional ID transmitter 13 is also present inside the passenger compartment, carried, for example, by a passenger.

The security system 25 can optionally be equipped with an additional electrode 18 arranged in the driver's seat 19. Through this security electrode 18, it can be established by the security system 25 whether the operator 30 is actually situated on the driver's seat 19 when he operates the switching device 1. For this purpose, capacitive coupling to the mobile ID transmitter 13 is also possible through electrode 18. The security electrode 18 is connected, in turn, to the control unit 10. Data from the capacitive signal is transmitted through capacitor 33 and the operator 30 to capacitor 34. If the ID transmitter receives the signal from electrode 18, it can send an additional release signal. It is also conceivable that the ID transmitter 13 only emits the identification signal to the control unit when it has received two different activation signals from electrode 5 and electrode 18. The special arrangement of electrode 18 is not restricted to the driver's seat 19. Instead, it is conceivable that this electrode 18 is also arranged in the steering wheel or a pedal, especially the brake pedal, or elsewhere, in order to be able to perform additional position monitoring of the operator 30. As already mentioned previously, the security system 25 can also be used to secure additional electronic loads, such as a radiotelephone or navigation system, etc., in a vehicle, in order to prohibit other vehicle occupants, for example, children, from operating them. For this purpose, the system 25 can also contain several switching devices 1.

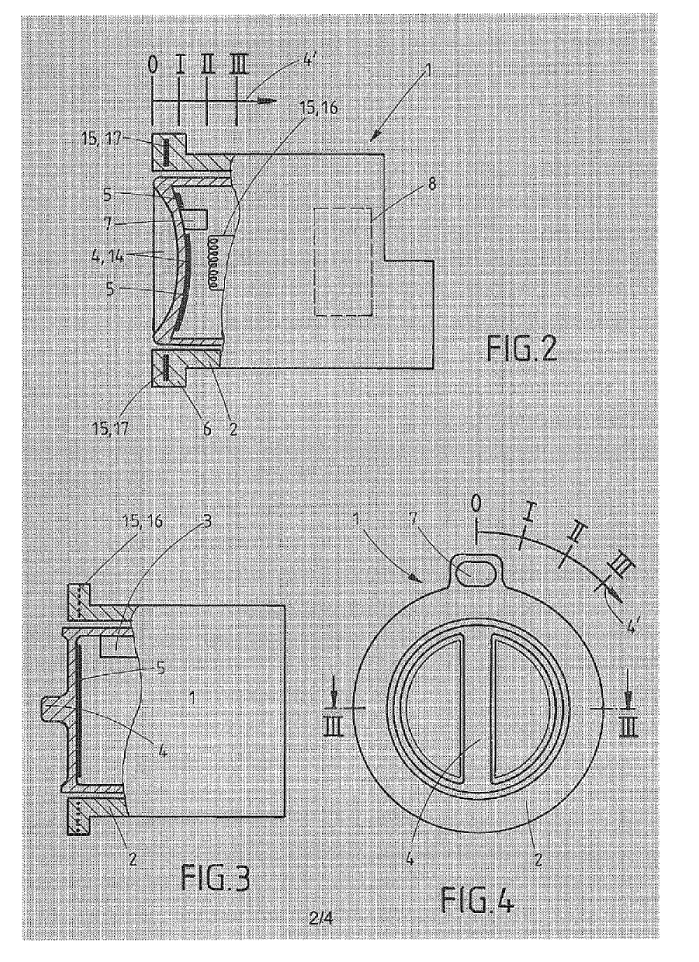

FIG. 2 shows a switching device 1 according to the invention, with an operating element 4 to be moved in a translatory manner. If an operator 30 now presses the operating element 4 with his finger, different switching positions (for example, switch positions 0 and I or 0-III) can be operated. Each of these switching positions can be assigned a corresponding switching signal that is conveyed to the control unit 10. Mechanical or electromechanical locking of the switching device 1 is not prescribed, regardless of whether the operator 30 can be identified or not by the correct mobile ID transmitter 13. Only by checking/identification is a situation achieved in which the switching signal present, which is generated by the switching device 1, is conveyed by the control unit 10 to the management system 12 or another load when the corresponding identification code is present from the ID transmitter. A simple design of the switching device 1 is thereby possible. The switching element 3, operated by the operating element 4, can consist of a switch, a raster, a key, a piezo element, etc. In a piezo element, it is conceivable, for example, that the operating pressure applied on the operating element 4 is measured, in order to distinguish the individual switching position 0 and I or 0-III. For this purpose, the switching device 1 can have its own logic unit or logic component 8 arranged in the housing 2. An additional sensor element can also be provided on the surface of the operating element 4 that serves to identify the fingerprint of an operator 30. Corresponding evaluation of the measurement signal determined by the sensor element can also be implemented by the logic component 8.

For capacitive data transmission, a surface electrode 5 is provided, which is arranged on the inside of the operating element 4. This electrode 5 can be glued, evaporated, welded on, or attached in some other way to the operating element 4. In order for the operating element 4 to additionally contain a display element 7, the capacitive electrode 5 has a recess, in which the display element 7 is arranged. This recess can consist of a hole. The described electrode is connected to control unit 10 by a direct or indirect connection. The switching device 1 can naturally be connected to the control unit by means of a plug. Optoelectronic coupling or connection 20 of the switching device 1 to the control unit 10 is then also conceivable. Another electrode 17 is additionally provided in the housing 2 of switching device 1 for an optional power-transmission unit 15. This electrode is directly welded into the housing 2. This electrode 17 can also be connected directly or indirectly to the control unit 10. It is also conceivable that the electrode 17 also belongs to electrode 5 and is electrically connected to it. In this case, capacitive power transmission would then not be needed. A coil 16 is also optionally provided in FIG. 2, which can also send the required power to a currentless ID transmitter 13. This coil 16 then also represents an element of the power-transmission unit 15. Actual power transmission from switching device 1 to the mobile ID transmitter 13 preferably then occurs when the ID transmitter 13 is brought into the vicinity of switching device 1. As already previously mentioned, the arrangement of electrode 17 represents an optional means for the coil 16 of the power-transmission unit 15. In order to improve power transmission by the coil 16, a recess in the capacitive electrode 5 can also be provided in the middle area, where the coil 16 is arranged on the back. It is also conceivable to arrange the coil 16 in front of electrode 5 on the operating element 4 and not behind electrode 5, as shown.

Another variant of the switching device 1 according to the invention is shown in FIG. 3. The switching element 3 in this variant is shown as a rotary switch with several switch positions (for example, 0 and I or 0-III). The direction of rotation of the operating element 4 is indicated by arrow 4′. It is also conceivable that a translatory activation is possible with the rotational movement of the operating element 4, in other words, the operating element 4 can additionally be pulled out or pushed into the switching device 1, so that an additional switch position can be reached. This variant can therefore be used directly similar to an ordinary ignition-starter switch with a mechanical key. The electrode 5 necessary for capacitive data transmission is also provided in this case on the back or inside of the operating element 4. The capacitive electrode 5 can consist of an electrically conducting film or layer or grid structure. This switching device 1 is also provided with a power transmission unit 15, in order to be able to transmit power to a mobile ID transmitter 13 in an emergency. For this purpose, a coil 16 is introduced into the housing 2, especially into a protrusion 6. The protrusion 6 simultaneously serves as a stop for retaining the switching device 1 in a switch panel or a dashboard, etc.

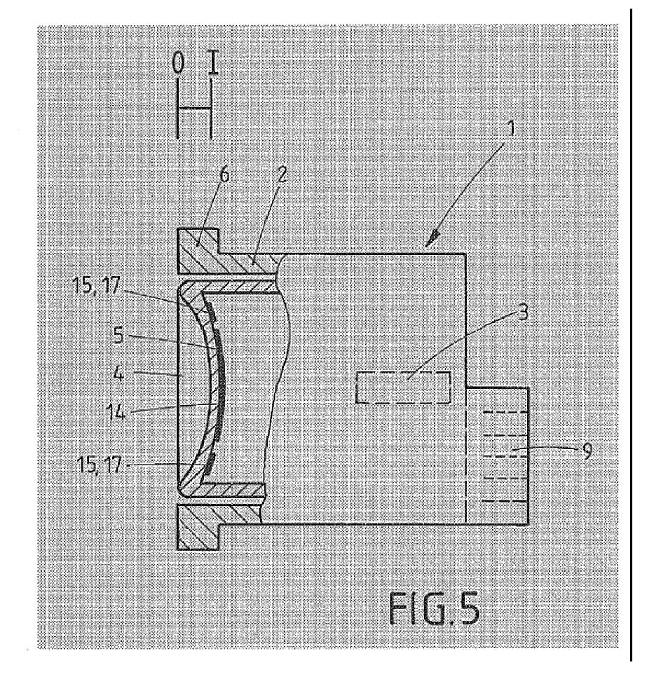

As can be seen from FIG. 4, the switching device 1 has a display element 7, which can consist of a multicolored display, in order to display different switching states of the switching device 1 or functional states of the security system 25. Several displays 7 can naturally also be arranged in the housing 2 or even the operating element 4. It is also conceivable that acoustic signals, especially speech signals, can be issued by the display element 7.

Another example for the switching device 1 according to the invention is shown in FIG. 5. This switching device 1 is designed similar to the switching device 1 from FIG. 2, whereby a one-state switching element 3 with switching states 0 and I is provided. In this case, an operating element 4 is also used as a key or push element. The actual switching element 3, which assigns a switching signal 0 or I to the corresponding operating state of the operating element 4, is shown schematically. A total of two electrodes 5 and 17 are additionally provided on the inside of operating element 4, electrode 5 being provided for capacitive data transmission and electrode 17 serving for power transmission to the mobile ID transmitter 13. The annular electrode 17 then encloses the circular electrode 5. It is also conceivable that the two electrodes 5, 17 are exchanged, so that no changes are produced to the method of function of the switching device 1. In addition, FIG. 5 shows schematically the individual plug contacts of plug 9. The switching device 1 is preferably connected to the control unit 10 by a standard plug. Instead of an electrical connection 20, an optical or optoelectronic connection 20 to the control unit 10 can also exist. Naturally, the connection 20 can also be achieved by an ordinary interface or an ordinary data-bus format.

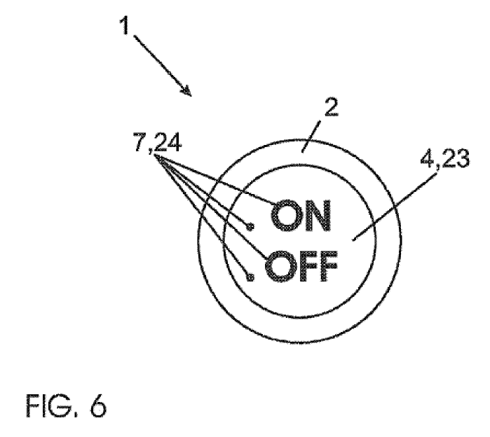

A top view of another variant of the switching device 1 according to the invention is shown in the last FIG. 6. This essentially shows the operating element 4 illuminated by a display element 7. At least the inscriptions “ON” and “OFF” can be displayed on the operating element 4 by the display element 7. For this purpose, the operating element 4 can consist of a transparent plastic. A film 23 with transparent areas 24 for the inscriptions can be arranged behind the operating element 4, the inscriptions being illuminated from the rear by the display element 7, in order to have the inscriptions appear. The display element 7 can consist of one or more light sources, such as LEDs, for this purpose. Different colors can also be emitted by the display element 7. The above-mentioned film 23 is advantageously configured to be electrically conducting and is used as a large-area electrode 5. It is also conceivable that the film 23 itself serves as a (color) display and emits light. In this case, the film 23 can serve as a surface electrode 5. This electrically conducting film 23 can be connected electrically to another part of the surface electrode 5, which is arranged, for example, on the housing 2 or the switching device 1.

Finally, it must be mentioned that the invention is not restricted to the variant shown of the switching device 1 or the security system 25. All combinations of individual technical features are conceivable, as long as they do not explicitly exclude each other out. The practical examples shown of the switching device 1, as well as the security system 25, can also contain additional mechanical, electrical, and/or electronic components not shown.

1. A switching device for keyless switching on or switching off of a load in a vehicle, and/or for unlocking or locking of components of a vehicle essential to function, comprising;
at least one switching element arranged in a switch housing, which is operable by an operating element, so that at least one switching signal can be generated for a control unit,
wherein an electrode is provided on a control unit housing, which is connected to the control unit, whereby the electrode serves for data transmission to a mobile ID transmitter and the electrode, through a capacitive coupling permits data transmission to the mobile ID transmitter, whereby the control unit sends a first coded, modulated, or coded and modulated signal through the electrode when it receives a first switching signal from the switching element.

2. A switching device according to claim 1, wherein the switching element has various switching positions, a distinct switching signal being assigned to each switching position.

3. A switching device according to claim 1, wherein the switching element assumes different switch positions by at least one of a translatory and rotary movement (4′) of the operating element (4).

4. A switching device according to claim 1, wherein at least one additional switching element is connected to the control unit.

5. A switching device according to claim 1, wherein the capacitive electrode, through which capacitive coupling to ID transmitter is made possible, comprises electrical insulation.

6. A switching device according to claim 5, wherein at least one of the operating element and the housing is provided as electrical insulation for the capacitive electrode.

7. A switching device according to claim 1, wherein the electrode comprises several parts.

8. A switching device according to claim 1, wherein the electrode comprises at least one of plate and/or film form.

9. A switching device according to claim 1, wherein the electrode is arranged over a large surface behind the surface of at least one of the operating element and the housing.

10. A switching device according to one of the preceding claims, wherein at least one of an optical and an acoustic display device is present, with which information can be displayed.

11. A switching device according to claim 10, wherein the optical display device contains at least one LED or display.

12. A switching device according to claim 10, wherein an electrically conducting film in or in front of the display device is used, which has transparent areas, the film serving partially or fully as the electrode.

13. A switching device according to claim 1, wherein a sensor element with a support surface is provided, whereby a test object can be placed on the support surface.

14. A switching device according to claim 1, wherein a power transmission unit is present, whereby electrical power can be transmitted from the switching device to the mobile ID transmitter, so that it is functional without its own power supply or during a failure of its own power supply.

15. A switching device according to claim 14, wherein the power transmission unit permits inductive or capacitive power transmission, for which a coil or plate-like electrode is provided.

16. A switching device according to claim 1, wherein the switching device can be arranged on a steering wheel.

17. A switching device according to claim 1, wherein the switching device can be arranged on at least one of a switch lever, a center console, a multifunctional operating unit, a dashboard, an inner panel of doors, a roof liner, a rearview mirror, and at a left and right of a steering wheel in a vehicle.

18. A security system for keyless activation or deactivation of a system or a device comprising:
a switching device according to claim 1 and a mobile ID transmitter, whereby capacitive data transmission occurs between the switching device and the ID transmitter; and
a control unit that controls data transmission between the switching device and the mobile ID transmitter.

19. A security system according to claim 18, further comprising a receiving unit that receives by radio, identification data from the mobile ID transmitter, and sends it to the control unit, the control unit performing at least one of a reference/actual comparison and an evaluation of the received identification data, in order to then issue corresponding control signals in case of positive identification.

20. A security system according to claim 18, wherein the mobile ID transmitter serves for keyless access to a blockable area, in which the ID transmitter is also incorporated into an access control system.

21. A security system for a vehicle according to claim 18, further comprising an electrode in a driver's seat that is designed with a large area and connected to the control unit, the electrode serving for data transmission by capacitive coupling to the mobile ID transmitter.
